(19) United States
(12) Patent Application Publication
(10) Pub. No.: US 2008/0244018 A1
(43) Pub. Date: Oct. 2, 2008

(54) Personal communication gateway

(75) Inventors: Eric Chen, Fremont, CA (US); Arthur Lin, Saratoga, CA (US)

Correspondence Address: HARRINGTON & SMITH, PC, 4 RESEARCH DRIVE, SHELTON, CT, 06484-6212, US

(73) Assignee: Nokia Corporation

(21) Appl. No.: 11/729,072

(22) Filed: Mar. 27, 2007

(51) Int. Cl. G06F 15/16

(52) U.S. Cl. 709/206

(57) ABSTRACT

Disclosed is a method in a personal communication gateway. The method includes communicating with a user terminal through a personal area network interface, accessing multimedia services through a communication network interface, and operating as a proxy to provide for the user terminal access to the multimedia services through the personal area network interface. Also disclosed is a method in a user terminal, which method includes communicating with a personal communication gateway through a personal area network interface, and using the personal communication gateway as a proxy for accessing multimedia services.

### FIELD OF THE INVENTION

The present invention generally relates to communication systems and particularly, but not exclusively, to multimedia services and a personal communication gateway used for accessing multimedia services.

### BACKGROUND OF THE INVENTION

The use of mobile phone's multimedia capabilities/services, such as photo sharing, video sharing, music sharing, MIM (Multimedia Instant Messaging), PIM (Personal Information Management), etc. is increasing. The use of these services requires a data connection to an IMS (IP Multimedia Subsystem) network via a communication network, e.g. a GSM, 3G network, or WLAN, and also sufficient bandwidth to provide good quality of multimedia communication services.

There are two potential issues that may affect the market acceptance of using multimedia services. The first is the cost. In many cases, a mobile data connection is associated with significant costs. This is the case especially when the data connection is subject to roaming charges. Increased costs may clearly hinder the use of multimedia services.

The other issue is the quality and service coverage of cellular radio networks. Multimedia service applications are more sensitive to network connection quality than conventional call applications. The available data bandwidth and connection quality is in general good in 3G networks, but coverage of the network tends to vary geographically. For example in rural areas or when roaming, the available connection quality may be poor. Also this may hinder the use of multimedia services in wireless networks.

The cost issue can be solved by offering flat or flexible charging plan for data connections and the coverage issues can be solved by increasing the density of radio network cells. However, both of these are long term processes, which incur significant costs and may be subject to various policy factors.

In addition to cellular networks, WLAN is an alternative option for IMS connection. The problem associated with WLAN is that all mobile phones do not have WLAN capabilities and the ones that have may be expensive and the use of WLAN may cause a much higher battery power consumption rate than conventional usage of mobile phones. Thus, people may try to avoid using WLAN capabilities of their mobile phones.

Thus there is a need to consider alternative options for accessing multimedia services.

### SUMMARY

According to a first aspect of the invention there is provided a personal communication gateway, comprising:

a personal area network interface configured to communicate with a user terminal,
a communication network interface configured to have access to multimedia services, and
a processing unit configured to co-operate with the personal area network interface and the communication network interface and to operate as a proxy to provide for the user terminal access to the multimedia services through the personal area network interface.

By means of various embodiments of the invention one may enable a PC soft-client terminal to function as an IMS personal communication gateway and thereby provide a personal area network for mobile phones to have an alternative connection to access IMS services.

According to a second aspect of the invention there is provided a method in a personal communication gateway, the method comprising

communicating with a user terminal through a personal area network interface,
accessing multimedia services through a communication network interface, and
operating as a proxy to provide for the user terminal access to the multimedia services through the personal area network interface.

In an embodiment of the invention, the method of the second aspect comprises

receiving personal area network messages carrying multimedia data,
demultiplexing the received personal area network messages, and
transforming the demultiplexed personal area network messages into multimedia communication messages to be used for accessing the multimedia services.

In a further embodiment of the invention, the method of the second aspect comprises

receiving, through the communication network interface, multimedia communication messages carrying multimedia data,
transforming the received multimedia communication messages into personal area network messages to be transmitted through the personal area network interface, and
multiplexing the personal area network messages.

The multimedia services may be for example IMS services. The multimedia services may include one or more of the following: multimedia instant messaging, personal information management, SMS, MMS, voice/video calls, media sharing, file transfer, and call forwarding. The multimedia communication messages may comprise one or more of the following: session initiation protocol messages, real time transport protocol messages, real time streaming protocol messages, and transmission control protocol messages.

In an embodiment of the invention the multimedia services provided to the user terminal through the personal area network interface are bi-directional. Additionally or alternatively, personal area network messages may be sent and received over a single channel.

In an embodiment of the invention, a specific communication profile, which allows transportation of multiple types of multimedia data within a single personal area network connection, is used for providing for the user terminal access to the multimedia services through the personal area network interface. This embodiment may be used for example in connection with using Bluetooth technology for the personal area network connection. In that case the specific communication profile is for example Bluetooth Serial Port profile.

According to a third aspect of the invention there is provided a memory medium comprising computer executable program code configured to cause a device to perform the method according to the second aspect of the invention.

According to a fourth aspect of the invention there is provided a user terminal comprising

a personal area network interface configured to communicate with a personal communication gateway, and
a processing unit configured to co-operate with the personal area network interface to use the personal communication gateway as a proxy for accessing multimedia services.

According to a fifth aspect of the invention there is provided a method in a user terminal, the method comprising

communicating with a personal communication gateway through a personal area network interface, and
using the personal communication gateway as a proxy for accessing multimedia services.

In an embodiment of the invention, the method of the fifth aspect comprises

encapsulating multimedia data intended for multimedia services into personal area network messages,
multiplexing the personal area network messages, and
sending the multiplexed personal area network messages to the personal communication gateway.

In a further embodiment of the invention, the method of the fifth aspect comprises

receiving personal area network messages carrying multimedia data related to multimedia services,
demultiplexing the received personal area network messages, and
decapsulating the multimedia data carried in the personal area network messages.

The multimedia services may be for example IMS services. The multimedia services may include one or more of the following: multimedia instant messaging, personal information management, SMS, MMS, voice/video calls, media sharing, file transfer, and call forwarding.

In an embodiment of the invention the multimedia services accessed through the personal communication gateway are bi-directional. Additionally or alternatively, personal area network messages may be sent and received over a single channel.

In an embodiment of the invention, a specific communication profile, which allows transportation of multiple types of multimedia data within a single personal area network connection, is used for communicating with the personal communication gateway. This embodiment may be used for example in connection with using Bluetooth technology for the personal area network connection. In that case the specific communication profile is for example Bluetooth Serial Port profile.

According to a sixth aspect of the invention there is provided a memory medium comprising computer executable program code configured to cause a user terminal to perform the method according to the fifth aspect of the invention.

The memory medium of the third and sixth aspects may comprise a solid state, optical, magnetic or magneto-optical storage medium. The medium may be such as a flash-ram, memory tape, memory disc, floppy disc, compact disc (CD), digital versatile data disc (DVD).

According to a seventh aspect of the invention there is provided a system comprising a personal communication gateway and a user terminal, wherein the personal communication gateway comprises
a personal area network interface configured to communicate with the user terminal,
a communication network interface configured to have access to multimedia services, and
a processing unit configured to co-operate with the personal area network interface and the communication network interface and to operate as a proxy to provide for the user terminal access to the multimedia services through the personal area network interface,
   and wherein the user terminal comprises
a personal area network interface configured to communicate with the personal communication gateway, and
a processing unit configured to co-operate with the personal area network interface to use the personal communication gateway as a proxy for accessing multimedia services.

According to an eighth aspect of the invention there is provided a personal communication gateway comprising

means for communicating with a user terminal through a personal area network interface,
means for accessing multimedia services through a communication network interface, and
means for operating as a proxy to provide for the user terminal access to the multimedia services through the personal area network interface.

According to a ninth aspect of the invention there is provided a user terminal comprising

means for communicating with a personal communication gateway through a personal area network interface, and
means for using the personal communication gateway as a proxy for accessing multimedia services.

Various embodiments of the present invention have been illustrated only with reference to certain aspects of the invention. It should be appreciated that corresponding embodiments may apply to other aspects as well.

### BRIEF DESCRIPTION OF THE DRAWINGS

The invention will be described, by way of example only, with reference to the accompanying drawings, in which:

FIG. 1 shows a schematic picture of a system according to an embodiment of the invention;

FIG. 2A shows a flow diagram of a method in a personal communication gateway according to an embodiment of the invention;

FIG. 2B shows a flow diagram of another method in a personal communication gateway according to an embodiment of the invention;

FIG. 2C shows a flow diagram of a method in a user terminal according to an embodiment of the invention;

FIG. 2D shows a flow diagram of another method in a user terminal according to an embodiment of the invention;

FIG. 3 shows a block diagram of an system according to an embodiment of the invention;

FIG. 4 shows a block diagram of an apparatus suited for operating as a personal communication gateway according to various embodiments of the invention; and

FIG. 5 shows a block diagram of a user terminal suited for operating according to various embodiments of the invention.

### DETAILED DESCRIPTION

In the following description, like numbers denote like elements.

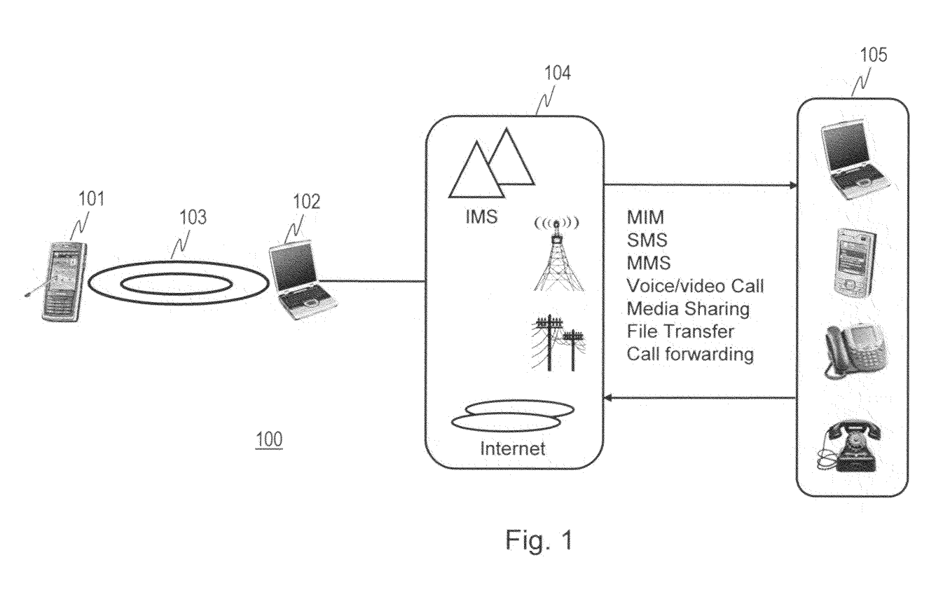

FIG. 1 shows a schematic picture of a system according to an embodiment of the invention. The system comprises a user terminal 101 and a laptop computer 102 operating as a personal communication gateway (PCG). The user terminal and the laptop computer are connected through a Bluetooth connection 103. Additionally or alternatively, the connection between the user terminal and the personal communication gateway may be through some other personal area network or near field connection, such as for example USB (Universal Serial Bus). By using Bluetooth or some other wireless near field communication technology one achieves that the user may maintain mobility. The laptop may alternatively be a desktop computer or even another user terminal, for example. The laptop 102 has a broadband connection to a multimedia service network 104. The multimedia service network may comprise IMS (IP Multimedia Subsystem) and/or internet application services. Further the system comprises other communicating parties 105 connected to the multimedia service network. Physical connection to the multimedia service network (from the laptop 102 and/or the other communicating parties 105) is through a communication network. The communication network may be for example internet or a proprietary communication network, and it may comprise fixed line or wireless connections or a suitable combination of them. The other communicating party may be for example another user terminal, computer, server or service reachable through the multimedia service network.

The laptop 102 acts as a proxy or a gateway to provide multimedia communication between the other communicating party 105 and the user terminal 102. The multimedia communication may be for example MIM (multimedia instant messaging), PIM (personal information management), SMS, MMS, voice/video calls, media (e.g. photo/video/music) sharing, file transfer, mobile phone call forwarding and so forth.

In the system of FIG. 1, the user terminal 101 only provides/receives the media and the laptop 102 is the entity accessing the multimedia service network. As an example in case of IMS services the laptop is the entity accessing the IMS.

In an embodiment of the invention messages are transported in both directions between the user terminal and the laptop over a single channel of the personal area network. That is, messages are received and sent over a single channel. In case of Bluetooth, for example a standard Bluetooth Serial Port Profile allows this. Alternatively, messages may be received and sent over different channels.

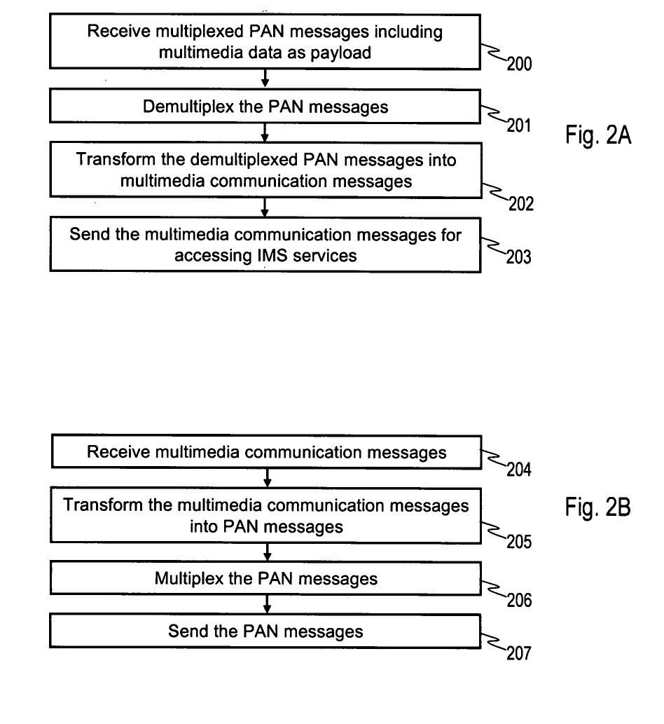

FIG. 2A shows a flow diagram of a method in a personal communication gateway according to an embodiment of the invention.

In phase 200 the personal communication gateway receives from a user terminal multiplexed PAN (personal area network) messages including multimedia data as payload. That is, PAN messages within one single connection may include different types of multimedia data. The PAN messages are demultiplexed in phase 201 and the multimedia data carried in the PAN messages is decapsulated in phase 202. Also the multimedia data carried in the PAN messages may be multiplexed. In that case the multimedia data is demultiplexed into different types (or separate pieces) of multimedia data after the decapsulation. The multimedia data is then transformed into multimedia communication messages, such as SIP (session initiation protocol) messages or RTP (real time transport protocol) messages for example, in phase 203. Then the multimedia communication messages are sent out for accessing IMS services in phase 204.

FIG. 2B shows a flow diagram of another method in a personal communication gateway according to an embodiment of the invention.

In phase 204, the personal communication gateway receives multimedia communication messages, such as SIP messages or RTP messages or other multimedia data messages, from the IMS. Various different types of multimedia communication messages relating to different multimedia services or different multimedia types may be received. In phase 205, the multimedia communication messages are transformed into PAN messages (the multimedia data carried in the multimedia communication messages is encapsulated as payload in PAN messages). In an embodiment of the invention, also the multimedia data carried in the multimedia communication messages may be multiplexed in this phase. The PAN messages are then multiplexed in phase 206, the multiplexed PAN messages are sent to the user terminal in phase 207.

The transforming in FIGS. 2A and 2B may also comprise transcoding the multimedia data. For example, the user terminal may use different media format than the multimedia communication messages. As an example, H.263 video format may be used in IMS while MJPEG (motion JPEG) may be used in the user terminal.

Like mentioned above the multimedia communication messages may be SIP messages or RTP messages. Additionally the multimedia communication messages may be TCP (Transmission Control Protocol) messages or RTSP (Real Time Streaming Protocol) messages. One option is that SIP messages are used for carrying control messages and some other protocol is used for carrying the actual multimedia data. Alternatively SIP may be used also for carrying multimedia data (in addition to control data), in which case there is no need to use other data transportation protocol. SIP may be used for example for carrying the data in photo sharing (file transfer).

FIG. 2C shows a flow diagram of a method in a user terminal according to an embodiment of the invention. The method may be performed for example in a PCG client application running in the user terminal.

In phase 210 the user terminal receives or captures multimedia data. For example, the user terminal may capture video that is later used in some multimedia service. The received or captured multimedia data may comprise plurality of different types of multimedia data. The multimedia data is encapsulated as payload in PAN messages in phase 211 and the PAN messages thereby obtained are then multiplexed in phase 212. In an embodiment of the invention also the multimedia data may be multiplexed before encapsulating into PAN messages. In phase 213, the multiplexed PAN messages are sent to a personal communication gateway for accessing multimedia services.

FIG. 2D shows a flow diagram of another method in a user terminal according to an embodiment of the invention. Also this method may be performed for example in a PCG client application running in the user terminal.

In phase 214, the user terminal receives from the personal communication gateway multiplexed PAN messages including multimedia data as payload. The PAN messages may be received for example in response to a request for a multimedia service. The user terminal then demultiplexes the PAN messages and decapsulates the multimedia data carried in the PAN messages in phase 215. If the multimedia data carried in the PAN messages is multiplexed as well, the user terminal demultiplexes also the multimedia data into different types (or separate pieces) of multimedia data. Thereafter the received multimedia data is handled in the user terminal according to the type of the multimedia data and/or associated service. As an example the user terminal may perform video rendering, playing music or voice call, saving or opening an attached file and so forth.

It must be noted that the methods shown in flow charts of FIGS. 2A-2D are only examples and that details of a specific implementation may be different from the shown examples. For example, the order of some phases may vary, some of the phases may be repeated and/or some of the phases may be left out. Further it is possible that actual multimedia data, such as music or video, is transported only in one direction (from the user terminal to the personal communication gateway or vice versa) and for example only a request for or a response to the multimedia data is transported in the other direction.

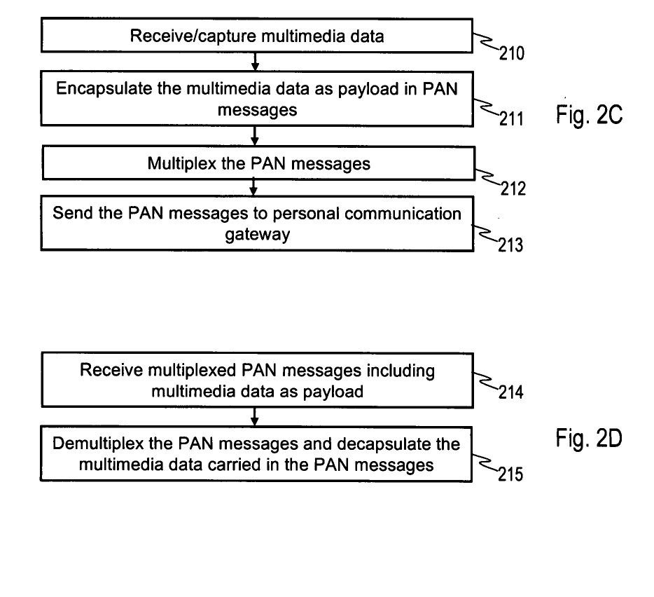

FIG. 3 shows a block diagram of a system according to an embodiment of the invention. The system comprises a user terminal 101, which may be for example the user terminal of FIG. 1, and a PC (Personal Computer) client 302, which may be for example a software running in the laptop 102 of FIG. 1.

The user terminal comprises a PCG client application 303. The PCG client application may perform the methods shown in FIGS. 2C and 2D. In an embodiment of the invention the PCG client application uses Bluetooth as a raw data transportation channel for transporting multimedia data between the user terminal 101 and the PC client 302. The standard Bluetooth Serial Port Profile may be used for this purpose. Bluetooth profile is a set of specifications that are negotiated in the beginning of a Bluetooth connection and that define the application for which a specific Bluetooth connection is used, e.g. file transfer or ear phone. By using the Serial Port Profile one achieves that different types of multimedia data can be transported over the same and single Bluetooth connection without a need to reconnect for changing the Bluetooth profile.

Based on the type of multimedia data embedded in the Bluetooth messages the PCG client application may then perform different tasks, such as video rendering, playing music or voice call, saving or opening an attached file and so forth.

It must be noted that the PCG client application is typically needed only in smart user terminals and for example in case of a so called dumb phone such application may not be required. The term dumb phone refers to an end user device having only very limited functionality (e.g. a USB phone or a Bluetooth phone). Such dumb phone usually requires a connection to a laptop (or other computer) and an associated software application running in the laptop. Some functionality of the PCG client may be included in such associated software application in case a dumb phone were used in connection with some embodiment of the invention.

The PC client 302 comprises a PCG function 304, which comprises a messaging mux-demux (multiplex-demultiplex) library 305 and a main thread 306. The mux-demux library 305 handles the Bluetooth messages received from (and sent to) the user terminal 101. That is, the library 305 demultiplexes multimedia data received from the user terminal into different types (or separate pieces) of multimedia data and multiplexes different types of multimedia data to be sent to the user terminal. Equivalent or similar functionality for multiplexing and demultiplexing multimedia data is provided in the PCG client 303. The main thread provides connection to internet/IMS by using multimedia communication messages such as SIP (Session Initiation Protocol) messages, RTP (Real Time Transport Protocol) messages or TCP (Transmission Control Protocol) messages. Additionally also RTSP (Real Time Streaming Protocol) messages may be used here.

In this embodiment of the invention the mux-demux library 305 is implemented in its own thread, which is separate from the main thread, so that the mux-demux library 305 splits the data carried over the Bluetooth connection into different pieces of data on the basis of multimedia data type. Thereby the main thread is able to do message transcoding appropriately before transmission to IMS as in IMS different message types are used for different types of multimedia and/or services.

Like mentioned above, in case of a dumb phone implementation, a client application in a user terminal is typically not needed. Instead some type of an API (Application Programming Interface) may be provided for allowing a software related to such dumb phones to communicate with the PC client 302 and to use the PC client 302 as a proxy for accessing multimedia services.

The invention may be implemented for example by means of a computer program running on a suitable hardware platform or by means of any other suitable combination of hardware, software, special purpose circuits and/or logic.

The functionality of a PCG may be for example part of an IMS PC soft-client, such as Nokia® Rich Call Client, or a VoIP (Voice over IP) PC client running in a laptop or some other device. Additionally or alternatively, the PCG functionality may be implemented in some other network access terminal, such as a home gateway or a SOHO (Small Office—Home Office) gateway used for accessing service provider's services like email, internet, fax and so forth, or a set-top box used for accessing TV cable services.

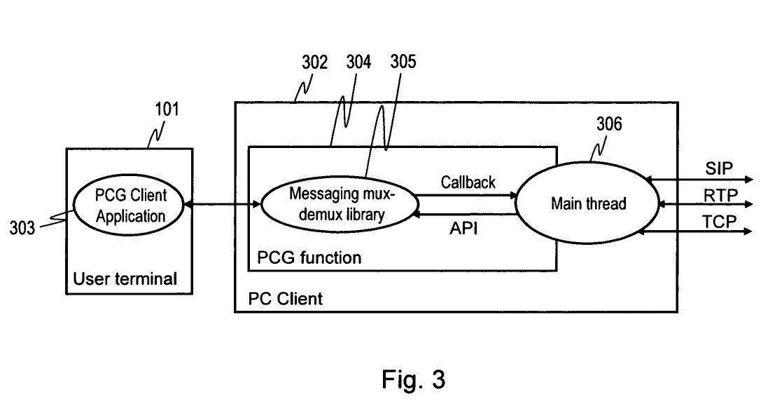

FIG. 4 shows a block diagram of an apparatus 400 suited for operating as a personal communication gateway implementing various embodiments of the invention. The apparatus 400 may be a typical computer, such as, a general-purpose computer or laptop. The apparatus may be also a home gateway, a SOHO gateway or a set-top box or an advanced mobile phone.

The apparatus comprises a network interface (N_IF) 405 for connecting to communication networks, a memory 402 comprising operating instructions, a processing unit 401 for executing the operating instructions and accordingly controlling other blocks of the apparatus, a user interface 406 for providing output to a user and reading user input, and a personal area network (PAN) interface 407 for communicating with devices in proximity of the apparatus 400.

The memory 402 includes a computer program code or software 403 that may comprise instructions for controlling the apparatus to provide some functionality of the invention. The instructions may for example control the apparatus to operate as a personal communication gateway according to some embodiments of the invention.

The processor is typically a central processing unit (CPU) or a master control unit MCU. Alternatively, the processor may be a microprocessor, a digital signal processor or an application specific integrated circuit, a field programmable gate array, a microcontroller or a combination of such elements. The user interface 406 typically comprises, for data output, a display and/or a speaker. For data input, the user interface 406 typically comprises one or more of the following: dedicated buttons, soft keys, touch screen, roller, microphone, voice recognition circuitry, and pointing device. The network interface 405 is an interface providing connectivity to data network. It may be for example a LAN (Local Area Network), Ethernet or WLAN (Wireless LAN) interface or some other communication interface and it may provide access to multimedia service networks, such as IMS. The PAN interface 407 may be for example a Bluetooth or a Universal Serial Bus (USB) interface.

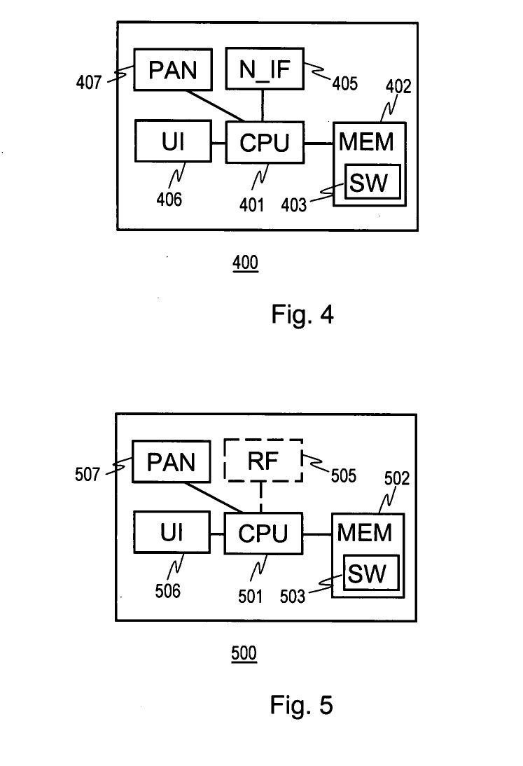

FIG. 5 shows a block diagram of a user terminal 500 suited for implementing various embodiments of the invention. The user terminal 500 may be a mobile terminal such as a cellular or satellite terminal compatible with a standard or proprietary communications protocol, or a so called dumb phone having only very limited functionality (e.g. a USB phone or a Bluetooth phone).

The user terminal comprises a memory 502 comprising operating instructions, a processing unit 501 for executing the operating instructions and accordingly controlling other blocks of the user terminal, a user interface 506 for providing output to a user and reading user input, and a personal area network (PAN) interface 507 for communicating with devices in proximity of the user terminal 500.

The memory 502 includes a computer program code or software 503 that may comprise instructions for controlling the user terminal to provide some functionality of the invention.

Additionally the user terminal may comprise a radio interface 505 (shown with dashed line) for connecting to wireless communication networks, such as WLAN, GSM, 3G and satellite communication networks, but the radio-interface is not necessarily needed in a user terminal suited for implementing the invention. For example in case of a dumb phone the radio interface may be non-existent.

The processor is typically a central processing unit (CPU) or a master control unit MCU. Alternatively, the processor may be a microprocessor, a digital signal processor or an application specific integrated circuit, a field programmable gate array, a microcontroller or a combination of such elements. The user interface 506 typically comprises, for data output, a display and/or a speaker. For data input, the user interface 506 typically comprises one or more of the following: dedicated buttons, soft keys, touch screen, roller, microphone, voice recognition circuitry, and pointing device. In case of a dumb phone, the user interface may have limited functionality. The PAN interface 507 may be for example a Bluetooth or a Universal Serial Bus (USB) interface.

It should be appreciated that in this document, words comprise, include and contain are used as open-ended expressions with no intended exclusivity.

Particular implementations and embodiments of the invention have been described by way of non-limiting examples. It is clear to a person skilled in the art that the invention is not restricted to details of the embodiments presented above, but that it can be implemented in other embodiments using equivalent means without deviating from the characteristics of the invention. Furthermore, some of the features of the above-disclosed embodiments of this invention could be used without the corresponding use of other features. As such, the foregoing description should be considered as merely illustrative of the principles of the present invention, and not in limitation thereof. Hence, the scope of the invention is only restricted by the appended patent claims.

1. A personal communication gateway, comprising:
a personal area network interface configured to communicate with a user terminal,
a communication network interface configured to have access to multimedia services, and
a processing unit configured to co-operate with the personal area network interface and the communication network interface and to operate as a proxy to provide for the user terminal access to the multimedia services through the personal area network interface.

2. A personal communication gateway according to claim 1, wherein the processing unit is configured
to receive personal area network messages carrying multimedia data,
to demultiplex the received personal area network messages, and
to transform the demultiplexed personal area network messages into multimedia communication messages to be used for accessing the multimedia services.

3. A personal communication gateway according to claim 2, wherein the multimedia communication messages comprise one or more of the following: session initiation protocol messages, real time transport protocol messages, real time streaming protocol messages, and transmission control protocol messages.

4. A personal communication gateway according to claim 1, wherein the processing unit is configured
to receive, through the communication network interface, multimedia communication messages carrying multimedia data,
to transform the received multimedia communication messages into personal area network messages to be transmitted through the personal area network interface, and
to multiplex the personal area network messages.

5. A personal communication gateway according to claim 4, wherein the multimedia communication messages comprise one or more of the following: session initiation protocol messages, real time transport protocol messages, real time streaming protocol messages, and transmission control protocol messages.

6. A personal communication gateway according to claim 1, wherein the multimedia services provided to the user terminal through the personal area network interface are bi-directional.

7. A personal communication gateway according to claim 1, wherein the processing unit in co-operation with the personal area network interface is configured to send and receive personal area network messages over a single channel.

8. A personal communication gateway according to claim 1, wherein the multimedia services comprise one or more of the following: multimedia instant messaging, personal information management, SMS, MMS, voice/video calls, media sharing, file transfer, and call forwarding.

9. A personal communication gateway according to claim 1, wherein the processing unit is configured to use a specific communication profile, which allows transportation of multiple types of multimedia data within a single personal area network connection, to provide for the user terminal access to the multimedia services through the personal area network interface.

10. A method in a personal communication gateway, the method comprising
communicating with a user terminal through a personal area network interface,
accessing multimedia services through a communication network interface, and
operating as a proxy to provide for the user terminal access to the multimedia services through the personal area network interface.

11. A method according to claim 10, further comprising
receiving personal area network messages carrying multimedia data,
demultiplexing the received personal area network messages, and
transforming the demultiplexed personal area network messages into multimedia communication messages to be used for accessing the multimedia services.

12. A method according to claim 11, wherein the multimedia communication messages comprise one or more of the following: session initiation protocol messages, real time transport protocol messages, real time streaming protocol messages, and transmission control protocol messages.

13. A method according to claim 10, further comprising
receiving, through the communication network interface, multimedia communication messages carrying multimedia data,
transforming the received multimedia communication messages into personal area network messages to be transmitted through the personal area network interface, and
multiplexing the personal area network messages.

14. A method according to claim 13, wherein the multimedia communication messages comprise one or more of the following: session initiation protocol messages, real time transport protocol messages, real time streaming protocol messages, and transmission control protocol messages.

15. A method according to claim 10, wherein the multimedia services provided to the user terminal through the personal area network interface are bi-directional.

16. A method according to claim 10, further comprising
sending and receiving personal area network messages over a single channel.

17. A method according to claim 10, wherein the multimedia services comprise one or more of the following: multimedia instant messaging, personal information management, SMS, MMS, voice/video calls, media sharing, file transfer, and call forwarding.

18. A method according to claim 10, further comprising
using a specific communication profile, which allows transportation of multiple types of multimedia data within a single personal area network connection, for providing for the user terminal access to the multimedia services through the personal area network interface.

19. A memory medium comprising computer executable program code configured to cause a device
to communicate with a user terminal through a personal area network interface,
to access multimedia services through a communication network interface, and
to operate as a proxy to provide for the user terminal access to the multimedia services through the personal area network interface.

20. A user terminal comprising
a personal area network interface configured to communicate with a personal communication gateway, and
a processing unit configured to co-operate with the personal area network interface to use the personal communication gateway as a proxy for accessing multimedia services.

21. A user terminal according to claim 20, wherein the processing unit is configured
to encapsulate multimedia data intended for multimedia services into personal area network messages,
to multiplex the personal area network messages, and
to send the multiplexed personal area network messages to the personal communication gateway.

22. A user terminal according to claim 20, wherein the processing unit is configured
to receive personal area network messages carrying multimedia data related to multimedia services,
to demultiplex the received personal area network messages, and
to decapsulate the multimedia data carried in the personal area network messages.

23. A user terminal according to claim 20, wherein the multimedia services accessed through the personal communication gateway are bi-directional.

24. A user terminal according to claim 20, wherein the processing unit in co-operation with the personal area network interface is configured to send and receive personal area network messages over a single channel.

25. A user terminal according to claim 20, wherein the multimedia services comprise one or more of the following: multimedia instant messaging, personal information management, SMS, MMS, voice/video calls, media sharing, file transfer, and call forwarding.

26. A user terminal according to claim 20, wherein the processing unit is configured to use a specific communication profile, which allows transportation of multiple types of multimedia data within a single personal area network connection, for communicating with the personal communication gateway.

27. A method in a user terminal, the method comprising
communicating with a personal communication gateway through a personal area network interface, and
using the personal communication gateway as a proxy for accessing multimedia services.

28. A method according to claim 27, further comprising
encapsulating multimedia data intended for multimedia services into personal area network messages,
multiplexing the personal area network messages, and
sending the multiplexed personal area network messages to the personal communication gateway.

29. A method according to claim 27, further comprising
receiving personal area network messages carrying multimedia data related to multimedia services,
demultiplexing the received personal area network messages, and
decapsulating the multimedia data carried in the personal area network messages.

30. A method according to claim 27, wherein the multimedia services accessed through the personal communication gateway are bi-directional.

31. A method according to claim 27, further comprising
sending and receiving personal area network messages over a single channel.

32. A method according to claim 27, wherein the multimedia services comprise one or more of the following: multimedia instant messaging, personal information management, SMS, MMS, voice/video calls, media sharing, file transfer, and call forwarding.

33. A method according to claim 27, further comprising
using a specific communication profile, which allows transportation of multiple types of multimedia data within a single personal area network connection, for communicating with the personal communication gateway.

34. A memory medium comprising computer executable program code configured to cause a user terminal
to communicate with a personal communication gateway through a personal area network interface, and
to use the personal communication gateway as a proxy for accessing multimedia services.

35. A system comprising a personal communication gateway and a user terminal, wherein the personal communication gateway comprises
a personal area network interface configured to communicate with the user terminal,
a communication network interface configured to have access to multimedia services, and
a processing unit configured to co-operate with the personal area network interface and the communication network interface and to operate as a proxy to provide for the user terminal access to the multimedia services through the personal area network interface,
and wherein the user terminal comprises
a personal area network interface configured to communicate with the personal communication gateway, and
a processing unit configured to co-operate with the personal area network interface to use the personal communication gateway as a proxy for accessing multimedia services.

36. A personal communication gateway comprising
means for communicating with a user terminal through a personal area network interface,
means for accessing multimedia services through a communication network interface, and
means for operating as a proxy to provide for the user terminal access to the multimedia services through the personal area network interface.

37. A user terminal comprising
means for communicating with a personal communication gateway through a personal area network interface, and
means for using the personal communication gateway as a proxy for accessing multimedia services.
